(19) United States
(12) Patent Application Publication
(10) Pub. No.: US 2014/0286133 A1
(43) Pub. Date: Sep. 25, 2014

(54) DEVICE-TO-DEVICE ANGLE DETECTION WITH ULTRASOUND AND WIRELESS SIGNAL

(71) Applicant: DEVICE-TO-DEVICE ANGEL DETECTION WITH ULTRASOUND AND WIRELESS SIGNAL, (unknown)

(72) Inventors: Honggang Li, Beijing (CN); Xintian Eddie Lin, Palo Alto, CA (US); Qinghua Li, San Ramon, CA (US); Hujun Yin, Saratoga, CA (US); Yongfa Zhou, Beijing (CN); Shantidev Mohanty, Santa Clara, CA (US)

(21) Appl. No.: 13/976,334

(22) PCT Filed: Mar. 15, 2013
(86) PCT No.: PCT/CN2013/072714

§ 371 Date: Jun. 26, 2013

(51) Int. Cl. G01S 5/18

(52) U.S. Cl. CPC G01S 5/18
USPC 367/117

(57) ABSTRACT

A method for determining orientation of an electronic device relative to another electronic device is described. The method includes synchronizing internal clock of a first electronic device with internal clock of a second electronic device using electromagnetic signals communicated between the first electronic device and the second electronic device, sending two or more sound waves from the second electronic device, receiving the two or more sound waves at the first electronic device, and calculating orientation of the first electronic device relative to the second electronic device based on a difference in time of arrival of the two or more sound waves at the first electronic device. The first electronic device and the second electronic device each have at least one transceiver configured to send and receive electromagnetic signals. The first electronic device has two or more acoustoelectric transducers and the second electronic device has one or more acoustoelectric transducer.

### TECHNICAL FIELD

This disclosure relates generally to the field of wireless communications, and in particular, to wireless communication systems and methods.

### BACKGROUND

Applications such as targeted advertising, warehouse navigation, store navigation, guided indoor tours, and so forth rely on accurate indoor position and contextual awareness. Satellite based positioning technologies such as Global Positioning System (GPS) generally have limited accuracy and applicability in indoor applications because of signal attenuation from construction materials and errors caused by multiple reflections at surfaces. Current indoor positioning technologies use electromagnetic waves for providing location data using triangulation and trilateration. However, these technologies also suffer from errors caused by multiple reflections at surfaces. The high speed of electromagnetic waves further limits the accuracy in determining distances using such technologies. Accordingly, a hardware solution for accurately providing distances and orientation for indoor situations is needed.

### BRIEF DESCRIPTION OF DRAWINGS

FIGS. 1 and 1A, each depict a schematic of two electronic devices equipped with apparatus for determining orientation of one electronic device relative to a second electronic device in accordance with various aspects and principles of the present disclosure.

FIG. 2 depicts a schematic of the calculations for determining orientation of one electronic device relative to a second electronic device in accordance with various aspects and principles of the present disclosure.

FIG. 3 depicts a schematic of the communication between two electronic devices equipped with apparatus for determining orientation of one electronic device relative to a second electronic device in accordance with various aspects and principles of the present disclosure.

FIG. 4 depicts a flow diagram for a process of determining orientation of one electronic device relative to a second electronic device in accordance with various aspects and principles of the present disclosure.

### DESCRIPTION OF EMBODIMENTS

In the description that follows, like components have been given the same reference numerals, regardless of whether they are shown in different embodiments. To illustrate an embodiment(s) of the present disclosure in a clear and concise manner, the drawings may not necessarily be to scale and certain features may be shown in somewhat schematic form. Features that are described and/or illustrated with respect to one embodiment may be used in the same way or in a similar way in one or more other embodiments and/or in combination with or instead of the features of the other embodiments.

In accordance with various embodiments of this disclosure, what is disclosed is an electronic device including at least one transceiver configured to send and/or receive electromagnetic signals used for communicating with a second electronic device comprising one or more acoustoelectric transducers and at least one transceiver configured to send or receive electromagnetic signals, wherein timing of each of the electronic device and the second electronic device is synchronized using electromagnetic signals communicated between the electronic device and the second electronic device, and two or more acoustoelectric transducers, wherein orientation of the electronic device relative to the second electronic device is calculated based on a difference in times of arrival of one or more sound waves transmitted from or received at the two or more acoustoelectric transducers.

In another embodiment, a method for determining orientation of a first electronic device relative to a second electronic device is presented. The method includes synchronizing timing of the first electronic device with timing of the second electronic device using electromagnetic signals communicated between the first electronic device and the second electronic device, wherein the first electronic device comprises two or more acoustoelectric transducers and at least one transceiver configured to send or receive electromagnetic signals, and the second electronic device comprises one or more acoustoelectric transducer and at least one transceiver configured to send and/or receive electromagnetic signals, and calculating orientation of the first electronic device relative to the second electronic device based on a difference in time of arrival of one or more sound waves transmitted from or received at the two or more acoustoelectric transducers.

In yet another embodiment, an indoor positioning system is described. The indoor positioning system includes a first electronic device having at least one transceiver configured to send and/or receive electromagnetic signals used for communicating with another electronic device configured to send or receive electromagnetic signals and two or more acoustoelectric transducers, and a second electronic device having at least one transceiver configured to send and/or receive electromagnetic signals used for communicating with another electronic device configured to send or receive electromagnetic signals, and one or more acoustoelectric transducers, wherein timing of each of the first electronic device and the second electronic device is synchronized using electromagnetic signals communicated between the first electronic device and the second electronic device, wherein orientation of the first electronic device relative to the second electronic device is calculated based on a difference in times of arrival of one or more sound waves transmitted from or received at the first electronic device.

As used herein, “sound”, or “sound waves” refer to mechanical waves that are oscillations of pressure through a medium. The sound waves may be in the sub-sonic frequency range (less than about 20 Hz), sonic or audible frequency range (about 20 Hz to about 20 kHz), or ultrasonic frequency range (greater than about 19.5 kHz). In various embodiments, it may not be preferable to use sound waves in the audible frequency range. It is noteworthy that because lower frequency waves have higher wavelength, generation of lower frequency sound waves may require larger equipment which may pose unacceptable size limitations in some embodiments. Accordingly, using sound waves in the sub-sonic frequency range may not be preferable in some embodiments such as portable or mobile electronic devices. In such embodiments, sound waves in the ultrasonic frequency range (i.e. having a frequency of greater than about 19.5 kHz) may be used. For example, the sound waves may have a frequency of about 19.5 kHz, about 20 kHz, about 25 kHz, about 30 kHz, about 35 kHz, about 40 kHz, or any frequency between any two of these frequencies.

As used herein, “sound signal” refers to sound waves having pre-determined parameters that are understood by both the electronic devices. The sound signal may be a sound wave of, for example, a known frequency, a known duration (pulse width), having a known phase, a known sequence of frequencies, a known sequence of pulse-widths, or any combination thereof.

As used herein, “acoustoelectric transducer” refers to a device capable of converting an electric signal to a sound signal or a sound signal to an electric signal. Such devices include, sound emitting devices (e.g. speakers, piezoelectric crystals, etc.) and sound sensing devices (e.g. capacitive microphones, acousto-optic microphones, magnetic microphones, etc.).

As used herein, “electromagnetic waves” refer to oscillating electromagnetic radiation having a frequency in any region of the electromagnetic spectrum. Thus, electromagnetic waves maybe radio waves, microwaves, infrared radiation, visible light (optical waves), ultraviolet radiation, X-rays or gamma rays. “Electromagnetic signal”, as used herein, refers to electromagnetic waves having pre-determined parameters and able to convey information about attributes of some phenomenon (e.g. a codified message). As such, electromagnetic signals may include signals having a frequency in any one or more of radio, microwave, infrared, visible (optical), ultraviolet, X-ray, and gamma-ray region of the electromagnetic spectrum.

As used herein, “transceiver” refers to any device that can receive and/or transmit wireless signals. Although the terms transceiver traditionally encompasses a device that can both transmit and receive signals, a transceiver when used in accordance with the present invention includes a device that can function solely as a receiver of electromagnetic signals, and not transmit electromagnetic signals or which transmits only limited electromagnetic signals. For example, in certain circumstances the transceiver may be located in a position where it is able to receive signals from a source, but not able to transmit signals back to the source or elsewhere. In some embodiments, the transceiver may have its transmission circuitry disabled, while in other embodiments, the transceiver may have its receiving circuitry disabled.

Devices, systems and methods for locating an electronic device in an indoor location are described. In various implementations, sound waves are used for determining orientation of one electronic device relative to a second electronic device. The two electronic devices are capable of communicating through electromagnetic waves using, for example, a wireless communication protocol. Such wireless communication is used to synchronize the two electronic devices, for example, by communicating data packets between the two electronic devices. The data packets may include, for example, synchronization signal to synchronize internal clocks of the two electronic devices, time at an electronic device when the electronic device sends and/or receives a data packet wirelessly, a time and/or times at which an electronic device sends or receives one or more sound waves, and so on. Besides time synchronization, the wireless signal can reserve the acoustic channel so that nearby devices may hold their transmissions of acoustic signals. The channel reservation reduces the mutual interference for nearby devices in multiuser environments.

One of the two devices is equipped with two or more acoustoelectric transducers capable of sending and/or receiving sound waves. The other electronic device is equipped with one or more acoustoelectric transducers capable of sending and/or receiving sound waves.

In one embodiment, once synchronized, the first electronic device sends sound waves which are received by the second electronic device. The second electronic device then measures a difference in times of arrival of sound waves at the second electronic device. This difference between times of arrival of different sound waves is used for calculating an angle made by the two electronic devices with respect to an arbitrarily chosen normal, thereby providing orientation of first electronic device relative to the second electronic device.

In another embodiment, once synchronized, the first electronic device sends one or more sound waves from one of its acoustoelectric transducers, which are received by the second electronic device. In a different time or frequency, the first device sends one or more sound waves from another one of acoustoelectric transducers, which are received by the second electronic device. The second electronic device then measures a difference in propagation time of the two sets of sound waves sent by the first electronic device. This difference between the propagation times of the different sets of sound waves is used for calculating an angle made by the two electronic devices with respect to an arbitrarily chosen normal, thereby providing orientation of second electronic device relative to the first electronic device. The computed orientation may be sent by the second device to the first device.

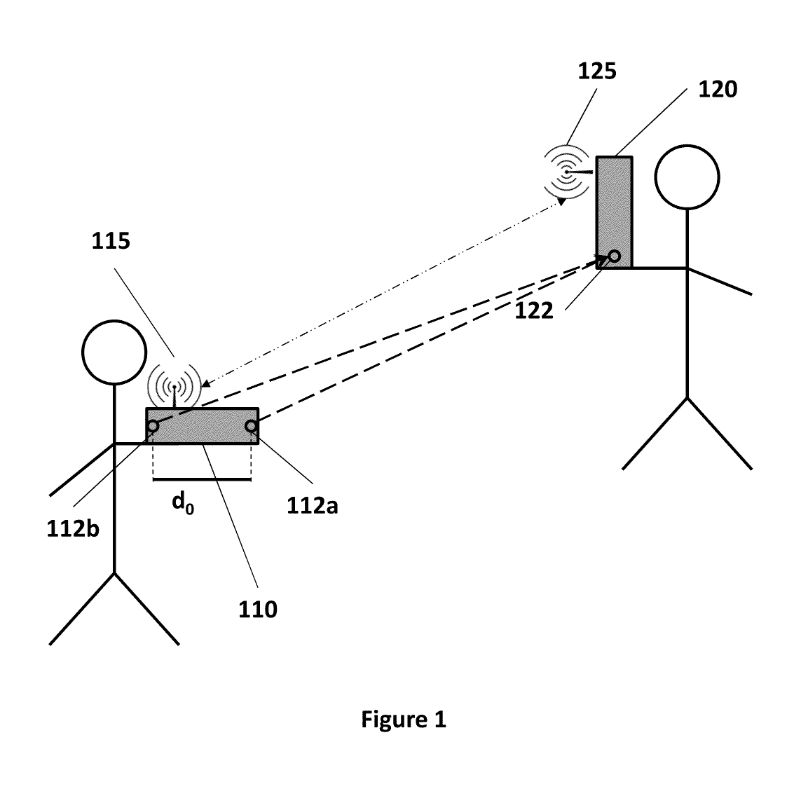

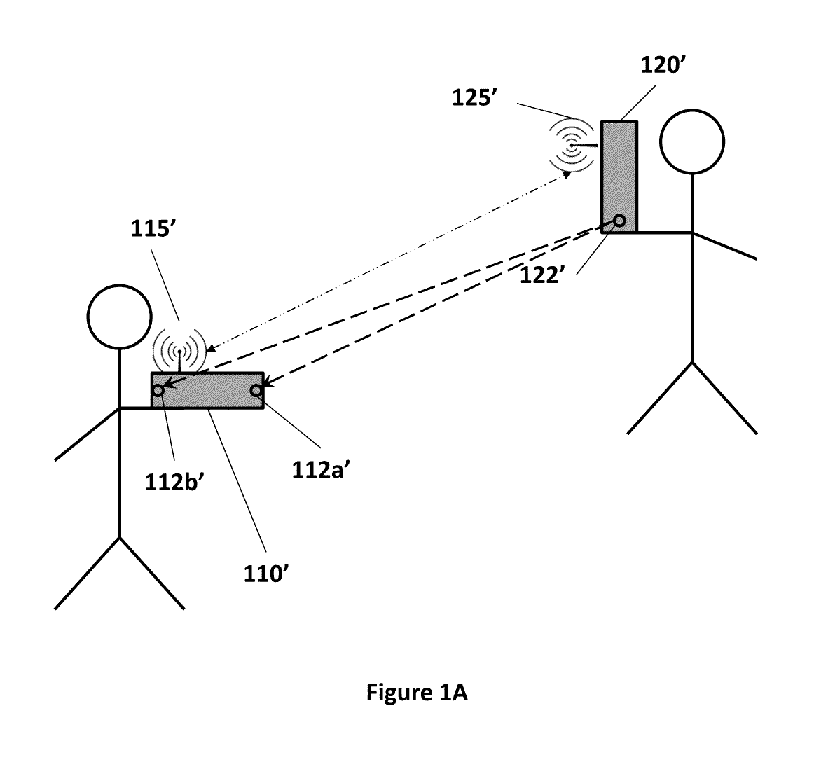

FIG. 1 depicts a schematic of two electronic devices equipped with apparatus for determining orientation of one electronic device relative to a second electronic device. In some embodiments, first electronic device 110 may have two sound emitting devices 112a and 112b, and transceiver device 115 for transmitting and receiving electromagnetic waves. Second electronic device 120 may include at least one sound sensing device 122, and transceiver device 125 for transmitting and receiving electromagnetic waves. Additionally, electronic devices 110 and 120 may include one or more processors (not shown) configured at least to parse the electromagnetic signals, measure time, calculate difference in times of arrival of various electromagnetic and/or sound waves, and perform other mathematical calculations relating to determination of relative orientation of the two electronic devices.

In some embodiments, first electronic device 110 may have more than two sound emitting devices (not shown). As used herein, “sound emitting device” generally refers to a device capable of generating and emitting sound waves. Examples of sound emitting devices include, but are not limited to, magnetic type sound generating device, piezoelectric crystals, capacitive type sound generating device, and so on. In various embodiments, sound emitting devices 112a and 112b may be externally attached to first electronic device 110, or they may be within the body of first electronic device 110 such as, for example, in case of a laptop or a mobile device. Two sound emitting devices 112a and 112b may be physically separated by a distance dₒ. In some embodiments, first electronic device 110 may additionally have one or more sound sensing devices (not shown).

In embodiments such as depicted in FIG. 1, second electronic device 120 may include at least one sound sensing device 122 (such as for example, a microphone). In some embodiments, second electronic device 120 may have more than one sound sensing device (not shown). In various embodiments, sound sensing device 122 may use electromagnetic induction, capacitance change, piezoelectric generation, or light modulation for generating electric signals from a sound wave. In some embodiments, a mechanical diaphragm based on micro-electro-mechanical (MEMS) technology may be used as a sound sensing device. Some embodiments of second electronic device 120 may additionally have one or more sound emitting devices.

In other embodiments, as depicted in FIG. 1A, first electronic device 110′ may have two sound sensing devices 112a′ and 112b′ and transceiver device 115′, and second electronic device 120′ may have one sound emitting device 122′ and transceiver device 125′. Yet other embodiments may include first electronic device 110′ having more than two sound sensing devices (not shown) and second electronic device 120′ having more than one sound emitting device (not shown). Similar to the embodiment depicted in FIG. 1, first electronic device 110′ and second electronic device 120′ may additionally include one or more processors.

Typically, the electromagnetic waves may be signals sent using, for example, WiFi, WiMax, WiFi Direct, Bluetooth, ZigBee, or any other wireless communication protocols. In some embodiments, the two electronic devices may communicate using one-way radio broadcast, two-way radio communication, cellular data service (GSM, CMDA, WCDMA, HSPDA, GPRS, LTE, and so on), UltraWide Band (UWB) communication, or any other ad hoc or proprietary wireless communication methods. Factors such as, for example, distance between the two electronic devices, availability of appropriate transceivers, power requirements, availability of bandwidth, and so forth may be used in determining which wireless protocol is used for communication between the two electronic devices. In some embodiments, the devices may communicate using more than one communication protocol.

Processor(s), as used herein, may include a single or multiple processing units, all of which may include single or multiple computing units. The processor(s) may be implemented as one or more microprocessors, microcomputers, microcontrollers, digital signal processors, central processing units, state machines, logic circuits and/or devices that manipulate signals based on operational instructions. Among other capabilities, the processor(s) may be configured to fetch and execute computer-readable instructions or processor accessible instructions stored in a memory (not shown), or other computer-readable storage media.

As used herein, “memory” generally refers to computer-readable storage media. Memory is an example of computer-readable storage media for storing instructions which are executed by the processor(s) to perform various functions described herein. Memory may generally include both volatile memory and non-volatile memory such as, for example, RAM, ROM, and the like. Memory is capable of storing computer-readable, processor executable program instructions as computer program code that may be executed by a processor as a particular machine configured for carrying out the operations and functions described herein.

First electronic device 110 and second electronic device 120 may use transceiver devices 115 and 125 to communicate time information with each other such that internal clocks of two electronic devices 110 and 120 can be synchronized. In some embodiments, first electronic device 110 may send, for example, present time at its internal clock, information about a future time when it may initiate further communication, information about a future time when it will be broadcasting sound signal(s), and so forth. In some embodiments, first device 110 may optionally use transceiver device 115 to send out information about its location and/or orientation. Likewise, second electronic device 120 may use transceiver device 125 to communicate with first electronic device 110. Second electronic device 120 may, in various embodiments, send information about its present time, time(s) at which it received communication from first electronic device 110, time(s) at which it received sound signal(s) from first electronic device 110, its location and/or orientation information, and so forth.

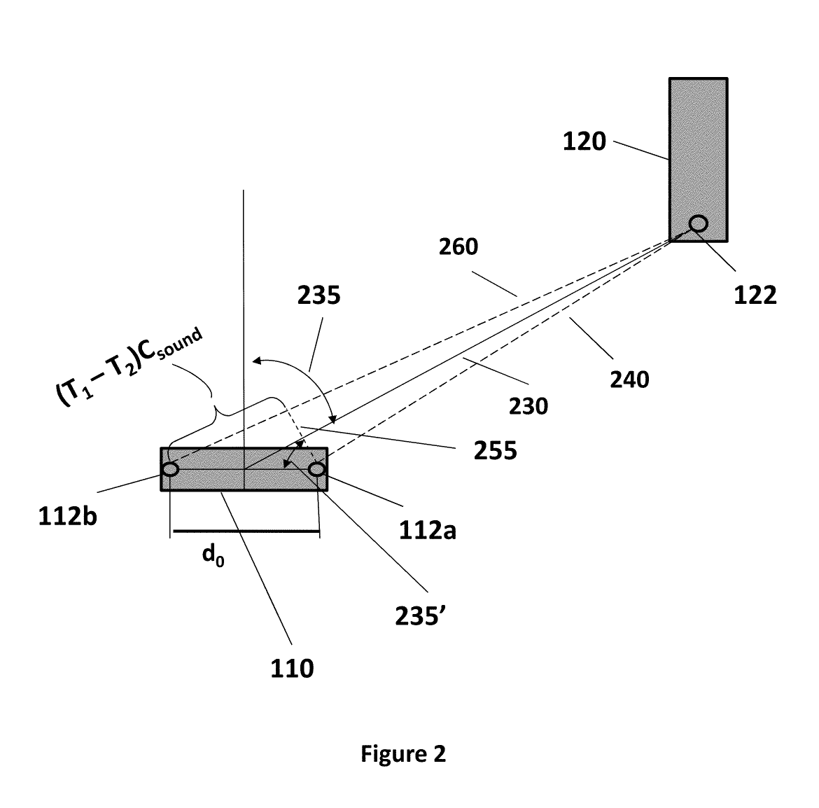

FIG. 2 depicts a schematic of the calculations for determining orientation of one electronic device relative to a second electronic device according to an embodiment. It is to be understood that the principles and calculation described herein are illustrative and as such, are not to be considered limiting. A person of ordinary skill in the art will be able to apply the principles and calculations, mutatis mutandis, to other embodiments (for example, as depicted in FIG. 1A) contemplated by the present disclosure. Exemplary configurations may include, first electronic device having at two sound emitting devices and second electronic device having one sound sensing device; first electronic device having two sound sensing devices and second electronic device having one sound emitting device; first electronic device having one sound emitting device and one sound sensing device and second electronic device having two sound sensing device; first electronic device having two sound sensing devices and one sound emitting device, and second electronic device having one sound emitting device; and so forth.

Once first electronic device 110 and second electronic device 120 have synchronized as described herein, first electronic device 110 broadcasts sound signals 240 and 260 using each of two sound emitting devices 112a and 112b. Because sound emitting devices 112a and 112b are physically separated (by a distance d₀), sound signals 240 and 260 arrive at sound sensing device 122 of second electronic device 120 at different times T₁ and T₂ respectively. Accordingly, the distance between sound emitting device 112a and sound sensing device 122 is T₁·C_{sound}, and the distance between sound emitting device 112b and sound sensing device 122b is T₂·C_{sound}, where C_{sound} is the speed of sound in the given conditions. Therefore, assuming that the distance between sound emitting devices 112a and 112b is small compared to the distance between first electronic device 110 and second electronic device 120, angle 235 formed by line 230 joining first electronic device 110 and second electronic device 120 with a line perpendicular to the line joining two sound emitting devices 112a and 112b can be calculated by the formula:

Angle=arcsin((T₁−T₂)·C_{sound}/d₀) (Equation 1).

Angle 235 provided by the Equation 1 may range from 0 to 2π radians (or 0 to 360°) and gives a user the relative orientation of second electronic device 120 with respect to first electronic device 110. Additionally, distance between first electronic device 110 and second electronic device 120 may be calculated using the formula:

$$Distance = ( \frac{{T}_{1} + {T}_{2}}{2} \cdot {C}_{sound} ) / {d}_{0} . \qquad ( Equation 2 )$$

Equipped with the angle and the distance between first electronic device 110 and second electronic device 120, a user of first electronic device 110 can estimate the relative position of second electronic device 120 with respect to first electronic device 110.

In some embodiments, suitable compensation may be applied to the calculations to account for the possibility multiple reflections of sound signals from various surfaces in the vicinity of the two electronic devices. In some embodiments, the compensation may take into account the phase and/or magnitude of a received sound signal as a function of the direction of reception of the sound signal. The compensation calculations may be performed by the one or more processors on the electronic devices.

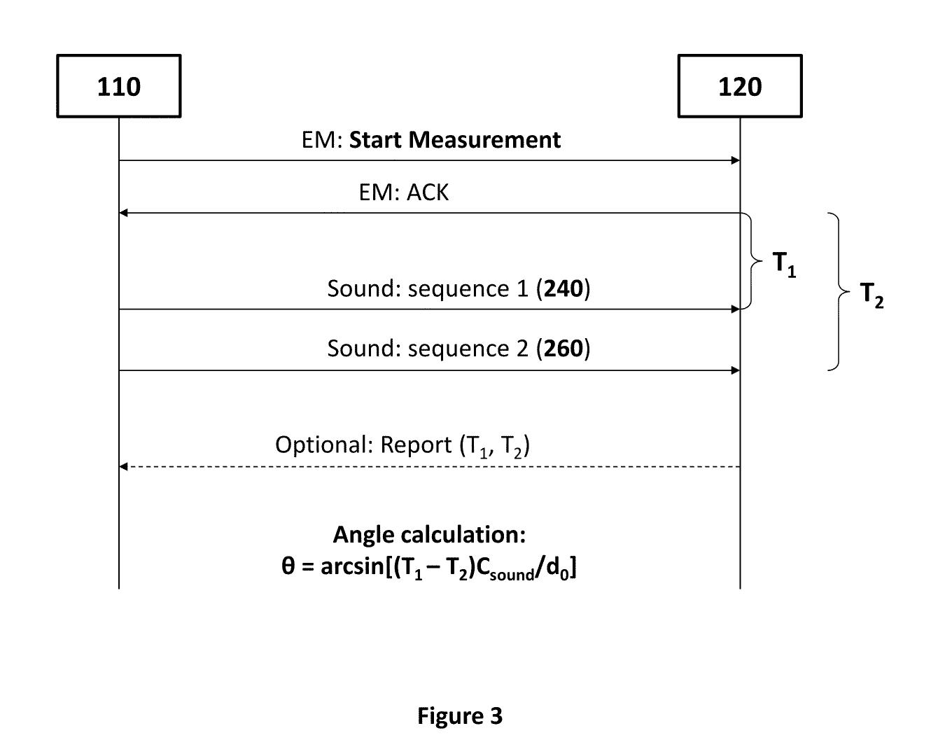

FIG. 3 depicts a schematic of the communication between two electronic devices equipped with apparatus for determining orientation of one electronic device relative to a second electronic device. It is to be understood that the communication described herein, is illustrative and as such, not to be considered limiting. The principles of communication described herein may be suitably applied, mutatis mutandis, to other embodiments contemplated in the present disclosure.

In some embodiments, first electronic device 110 broadcasts an electromagnetic signal “Start Measurement” to notify second electronic device 120 to get ready to start measurement. In some embodiments, this signal may include a request for an acknowledgement signal. Second device 120 may then send and acknowledgement signal “ACK”. First electronic device 110 may then broadcast sound signals 240 and 260. Upon receipt of sound signals 240 and 260, second electronic device 120 records the time at which each of the sound signals are received. Second electronic device 120 then sends this information to first electronic device 110 using an electromagnetic signal accepted by first electronic device 110. First electronic device 110 may then perform calculations according to Equation 1 and determine the relative orientation of second electronic device 120.

In various embodiments, the “Start Measurement” signal may be sent using any standard or proprietary wireless communication protocols, and may include information about synchronization of the two devices such as, for example, time at first electronic device 110, a future time at which first electronic device 110 may send sound signal(s) to second electronic device 120, information about parameters of the sound signal(s), information about various communication protocols that may be used by the first electronic device, information about addresses for various communication protocols on the first electronic device, and so forth.

Likewise, the “ACK” signal may be sent using any standard or proprietary wireless communication protocols and may include, inter alia, time at second electronic device 120.

In some embodiments, second electronic device 120 may include a processor and memory sufficient to perform calculations using Equation 1, for example. In such embodiments, second electronic device 120 may perform the calculations and send the results to first electronic device 110 using an electromagnetic signal accepted by first electronic device 110.

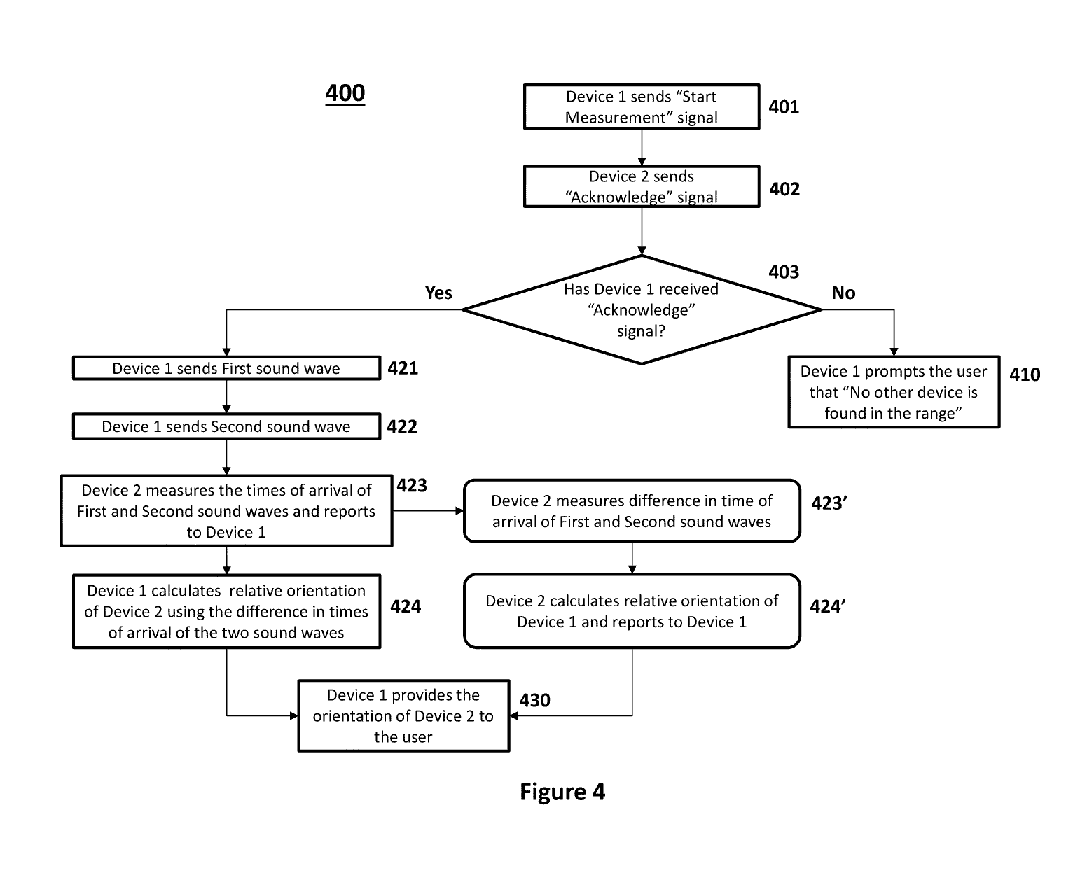

FIG. 4 depicts a flow diagram for a process of determining orientation of one electronic device relative to a second electronic device according to some embodiments disclosed herein. At block 401 of process 400, first electronic device 110 broadcasts a “Start Measurement” electromagnetic signal asking an electronic device in the vicinity of first electronic device 110 (Device 1) to get ready for receiving sound signals from first electronic device 110. At block 402, another (second) electronic device (Device 2) 120 in the vicinity receives the “Start Measurement” signal and sends an “Acknowledge” signal acknowledging that it has synchronized its internal clock with first electronic device 110 (Device 1) and is ready to receive sound signals and perform appropriate measurements.

At decision block 403, first electronic device 110 (Device 1) checks if it has received an “Acknowledge” signal. If there is No other device in the vicinity, or if No “Acknowledge” is received in a pre-determined time-out period (e.g., if the other device in the vicinity is not appropriately equipped for receiving sound waves or measuring time), at block 410, first electronic device 110 (Device 1) prompts the user that “No other device is found in the range”.

Once first electronic device 110 (Device 1) receives and “Acknowledge” signal (Yes), at block 421, first electronic device 110 (Device 1) sends first sound wave 240 using first sound emitting device 112a. At block 422, first electronic device 110 (Device 1) sends second sound wave 260 using second sound emitting device 112b. In some embodiments, block 421 and block 422 may be executed at the same time, and in some other embodiments, block 421 and block 422 may be executed after a pre-determined amount of time already communicated to second electronic device 120 (Device 2) using an electromagnetic signal (either along with the “Start Measurement” signal or separately).

At block 423, second electronic device 120 (Device 2) measures the times of arrival of first sound wave 240 (T₁) and second sound wave 260 (T₂) and reports back to first electronic device 110 (Device 1) using an electromagnetic signal. At block 424, first electronic device 110 (Device 1) calculates the relative orientation of second electronic device 120 (Device 2) using the difference in times of arrival of first sound wave 240 and second sound wave 260 at second electronic device 120 (Device 2). In embodiments, where there is a time difference between transmission of first sound wave 240 and second sound wave 260, first electronic device 110 (Device 1) may suitably account for the difference by subtracting that amount from the difference in times of arrival of two sound waves 240 and 260. Principles of calculation of the relative orientation are described herein (see Equation 1, for example).

In some embodiments, second electronic device 120 (Device 2) may be equipped one or more processors. In such embodiments, as an alternative process, at block 423′, second electronic device 120 (Device 2) calculates the difference in times of arrival of first sound wave 240, and second sound wave 260. At block 424′, second electronic device 120 (Device 2) calculates the relative orientation of first electronic device 110 (Device 1) using calculations similar to those described in Equation 1, and reports to first electronic device 110 (Device 1) using an electromagnetic signal.

At block 430, first electronic device 110 (Device 1) provides the user of first electronic device 110 with the relative orientation of second electronic device 120 (Device 2). It is to be understood that process 400, as described herein, is illustrative and thus, should not be considered limiting. Principles similar to the ones for process 400 described herein will apply, mutatis mutandis, to other embodiments having two suitably equipped electronic devices.

Having thus described the basic concepts, it will be rather apparent to those skilled in the art after reading this detailed disclosure that the foregoing detailed disclosure is intended to be presented by way of example only and is not limiting. Various alterations, improvements, and modifications will occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure. In addition, the term “logic” is representative of hardware, firmware, software (or any combination thereof) to perform one or more functions. For instance, examples of “hardware” include, but are not limited to, an integrated circuit, a finite state machine, or even combinatorial logic. The integrated circuit may take the form of a processor such as a microprocessor, an application specific integrated circuit, a digital signal processor, a micro-controller, or the like.

Furthermore, the recited order of processing elements or sequences, or the use of numbers, letters, or other designations therefore, is not intended to limit the claimed processes and methods to any order except as can be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, as the following claims reflect, inventive embodiments lie in less than all features of a single foregoing disclosed embodiment. Thus, the claims following the detailed description are hereby expressly incorporated into this detailed description.

### EXAMPLES

The following examples pertain to further embodiments,

Example 1 is an electronic device comprising at least one transceiver configured to send or receive electromagnetic signals used for communicating with a second electronic device comprising one or more acoustoelectric transducers and at least one transceiver configured to send or receive electromagnetic signals, wherein timing of each of the electronic device and the second electronic device is synchronized using electromagnetic signals communicated between the electronic device and the second electronic device; and two or more acoustoelectric transducers; wherein orientation of the electronic device relative to the second electronic device is calculated based on a difference in times of arrival of one or more sound waves transmitted from or received at the two or more acoustoelectric transducers.

Example 2 is the electronic device of Example 1, wherein each of the two or more sound waves has a frequency greater than about 19.5 kHz.

Example 3 is the electronic device of any one of Examples 1-2, wherein the two or more acoustoelectric transducers of the electronic device are sound emitting devices.

Example 4 is the electronic device of any one of Examples 1-3, wherein the two or more acoustoelectric transducers of the electronic device are sound sensing devices.

Example 5 is the electronic device of any one of Examples 1-4, wherein the at least one transceiver is configured to communicate with the second electronic device using wireless communication protocols including one or more of Bluetooth, WiFi, WiMax, WiFiDirect, WiGig, ZigBee, GSM, CDMA, and LTE.

Example 6 is the electronic device of any one of Examples 1-5, wherein the electronic device has two sound emitting devices and the second electronic device has one sound sensing device.

Example 7 is the electronic device of any one of Examples 1-6, wherein the electronic device has two sound sensing devices and the second electronic device has one sound emitting device.

Example 8 is the electronic device of any one of Examples 1-7, further comprising one or more processors configured to execute a computer program module configured to calculate compensation to account for reflection of sound waves from surfaces in vicinity of the electronic device and/or the second electronic device.

Example 9 is a method for determining orientation of a first electronic device relative to a second electronic device, the method comprising: synchronizing timing of the first electronic device with timing of the second electronic device using electromagnetic signals communicated between the first electronic device and the second electronic device, wherein the first electronic device comprises two or more acoustoelectric transducers and at least one transceiver configured to send or receive electromagnetic signals, and the second electronic device comprises one or more acoustoelectric transducer and at least one transceiver configured to send or receive electromagnetic signals; and calculating orientation of the first electronic device relative to the second electronic device based on a difference in time of arrival of one or more sound waves transmitted from or received at the two or more acoustoelectric transducers.

Example 10 is the method of Example 9, wherein each of the two or more sound waves has a frequency greater than about 19.5 kHz.

Example 11 is the method of any one of Examples 9-10, wherein the two or more acoustoelectric transducers of the first electronic device comprise sound sensing devices.

Example 12 is the method of any one of Examples 9-11, wherein the two or more acoustoelectric transducers of the first electronic device comprise sound emitting devices.

Example 13 is the method of any one of Examples 9-12, wherein the at least one transceiver is configured to communicate with the second electronic device using wireless communication protocols including one or more of Bluetooth, WiFi, WiMax, WiFiDirect, WiGig, ZigBee, GSM, CDMA, and LTE.

Example 14 is the method of any one of Examples 9-13, further comprising performing compensation calculations to account for reflection of sound waves from surfaces in vicinity of the first electronic device and/or the second electronic device.

Example 15 is an indoor positioning system comprising (i) a first electronic device comprising at least one transceiver configured to send or receive electromagnetic signals used for communicating with another electronic device configured to send or receive electromagnetic signals, and two or more acoustoelectric transducers; and (ii) a second electronic device comprising at least one transceiver configured to send or receive electromagnetic signals used for communicating with another electronic device configured to send or receive electromagnetic signals and one or more acoustoelectric transducers, wherein timing of each of the first electronic device and the second electronic device is synchronized using electromagnetic signals communicated between the first electronic device and the second electronic device; wherein orientation of the first electronic device relative to the second electronic device is calculated based on a difference in times of arrival of one or more sound waves transmitted from or received at the first electronic device.

Example 16 is the indoor positioning system of Example 15, wherein each of the two or more sound waves has a frequency greater than about 19.5 kHz.

Example 17 is the indoor positioning system of any one of Examples 15-16, wherein the two or more acoustoelectric transducers of the first electronic device are sound emitting devices.

Example 18 is the indoor positioning system of any one of Examples 15-17, the two or more acoustoelectric transducers of the first electronic device are sound sensing devices.

Example 19 is the indoor positioning system of any one of Examples 15-18, wherein each of the at least one transceiver of the first electronic device and the second electronic device is configured to communicate with another electronic device using wireless communication protocols including one or more of Bluetooth, WiFi, WiMax, WiFiDirect, WiGig, ZigBee, GSM, CDMA, and LTE.

Example 20 is the indoor positioning system of any one of Examples 15-19, wherein one or both of the first electronic device and the second electronic device further comprises a processor configured to execute a computer program module configured to calculate compensation to account for reflection of sound waves from surfaces in vicinity of the first electronic device and/or the second electronic device.

Example 21 is an electronic device comprising means for performing a method of any one of Examples 9-14.

Example 22 is an electronic device comprising a processor, in communication with a memory, for executing instructions to perform a method of any one of Examples 9-14.

Example 23 is a computer-readable medium comprising computer-readable code physically embodied thereon which, when executed by a processor, causes the processor to perform a method of any one of Examples 9-14.

Example 24 is an indoor positioning system comprising means for performing a method of any one of Examples 9-14.

Example 25 is an indoor positioning system comprising at least one electronic device comprising a processor, in communication with a memory, for executing instructions to perform a method of any one of Examples 9-14.

Example 26 is an electronic device comprising at least one transceiver configured to send or receive electromagnetic signals used for communicating with a second electronic device comprising one or more acoustoelectric transducers and at least one transceiver configured to send or receive electromagnetic signals, wherein timing of each of the electronic device and the second electronic device is synchronized using electromagnetic signals communicated between the electronic device and the second electronic device; and two or more acoustoelectric transducers; wherein orientation of the electronic device relative to the second electronic device is calculated based on a difference in times of arrival of one or more sound waves transmitted from or received at the two or more acoustoelectric transducers.

Example 27 is the electronic device of Example 26, wherein each of the two or more sound waves has a frequency greater than about 19.5 kHz.

Example 28 is the electronic device of Example 26, wherein the two or more acoustoelectric transducers of the electronic device are sound emitting devices.

Example 29 is the electronic device of Example 26, wherein the two or more acoustoelectric transducers of the electronic device are sound sensing devices.

Example 30 is the electronic device of Example 26, wherein the at least one transceiver is configured to communicate with the second electronic device using wireless communication protocols including one or more of Bluetooth, WiFi, WiMax, WiFiDirect, WiGig, ZigBee, GSM, CDMA, and LTE.

Example 31 is the electronic device of Example 26, wherein the electronic device has two sound emitting devices and the second electronic device has one sound sensing device.

Example 32 is the electronic device of Example 26, wherein the electronic device has two sound sensing devices and the second electronic device has one sound emitting device.

Example 33 is the electronic device of Example 26, further comprising one or more processors configured to execute a computer program module configured to calculate compensation to account for reflection of sound waves from surfaces in vicinity of the electronic device and/or the second electronic device.

Example 34 is a method for determining orientation of a first electronic device relative to a second electronic device, the method comprising synchronizing timing of the first electronic device with timing of the second electronic device using electromagnetic signals communicated between the first electronic device and the second electronic device, wherein the first electronic device comprises two or more acoustoelectric transducers and at least one transceiver configured to send or receive electromagnetic signals, and the second electronic device comprises one or more acoustoelectric transducer and at least one transceiver configured to send or receive electromagnetic signals; and calculating orientation of the first electronic device relative to the second electronic device based on a difference in time of arrival of one or more sound waves transmitted from or received at the two or more acoustoelectric transducers.

Example 35 is the method of Example 34, wherein each of the two or more sound waves has a frequency greater than about 19.5 kHz.

Example 36 is the method of Example 34, wherein the two or more acoustoelectric transducers of the first electronic device comprise sound sensing devices.

Example 37 is the method of Example 34, wherein the two or more acoustoelectric transducers of the first electronic device comprise sound emitting devices.

Example 38 is the method of Example 34, wherein the at least one transceiver is configured to communicate with the second electronic device using wireless communication protocols including one or more of Bluetooth, WiFi, WiMax, WiFiDirect, WiGig, ZigBee, GSM, CDMA, and LTE.

Example 39 is the method of Example 34, further comprising performing compensation calculations to account for reflection of sound waves from surfaces in vicinity of the first electronic device and/or the second electronic device.

Example 40 is an indoor positioning system comprising a first electronic device comprising at least one transceiver configured to send or receive electromagnetic signals used for communicating with another electronic device configured to send or receive electromagnetic signals; and two or more acoustoelectric transducers; and a second electronic device comprising at least one transceiver configured to send or receive electromagnetic signals used for communicating with another electronic device configured to send or receive electromagnetic signals; and one or more acoustoelectric transducers, wherein timing of each of the first electronic device and the second electronic device is synchronized using electromagnetic signals communicated between the first electronic device and the second electronic device; wherein orientation of the first electronic device relative to the second electronic device is calculated based on a difference in times of arrival of one or more sound waves transmitted from or received at the first electronic device.

Example 41 is the indoor positioning system of Example 40, wherein each of the two or more sound waves has a frequency greater than about 19.5 kHz.

Example 42 is the indoor positioning system of Example 40, wherein the two or more acoustoelectric transducers of the first electronic device are sound emitting devices.

Example 43 is the indoor positioning system of Example 40, wherein the two or more acoustoelectric transducers of the first electronic device are sound sensing devices.

Example 44 is the indoor positioning system of Example 40, wherein each of the at least one transceiver of the first electronic device and the second electronic device is configured to communicate with another electronic device using wireless communication protocols including one or more of Bluetooth, WiFi, WiMax, WiFiDirect, WiGig, ZigBee, GSM, CDMA, and LTE.

Example 45 is the indoor positioning system of Example 40, wherein one or both of the first electronic device and the second electronic device further comprises a processor configured to execute a computer program module configured to calculate compensation to account for reflection of sound waves from surfaces in vicinity of the first electronic device and/or the second electronic device.

Example 46 is a computer-readable medium comprising computer-readable code physically embodied thereon which, when executed by a processor, causes the processor to perform a method of Example 34.

Example 47 is a computer-readable medium comprising computer-readable instructions to implement, when executed, the method of any one of Examples 9-14.

1. An electronic device comprising:
at least one transceiver configured to send or receive electromagnetic signals used for communicating with a second electronic device comprising one or more acoustoelectric transducers and at least one transceiver configured to send or receive electromagnetic signals,
wherein timing of each of the electronic device and the second electronic device is synchronized using electromagnetic signals communicated between the electronic device and the second electronic device; and
two or more acoustoelectric transducers;
wherein orientation of the electronic device relative to the second electronic device is calculated based on a difference in times of arrival of one or more sound waves transmitted from or received at the two or more acoustoelectric transducers.

2. The electronic device of claim 1, wherein each of the two or more sound waves has a frequency greater than about 19.5 kHz.

3. The electronic device of claim 1, wherein the two or more acoustoelectric transducers of the electronic device are sound emitting devices.

4. The electronic device of claim 1, wherein the two or more acoustoelectric transducers of the electronic device are sound sensing devices.

5. The electronic device of claim 1, wherein the at least one transceiver is configured to communicate with the second electronic device using wireless communication protocols including one or more of Bluetooth, WiFi, WiMax, WiFiDirect, WiGig, ZigBee, GSM, CDMA, and LTE.

6. The electronic device of claim 1, wherein the electronic device has two sound emitting devices and the second electronic device has one sound sensing device.

7. The electronic device of claim 1, wherein the electronic device has two sound sensing devices and the second electronic device has one sound emitting device.

8. The electronic device of claim 1, further comprising one or more processors configured to execute a computer program module configured to calculate compensation to account for reflection of sound waves from surfaces in vicinity of the electronic device and/or the second electronic device.

9. A method for determining orientation of a first electronic device relative to a second electronic device, the method comprising:
synchronizing timing of the first electronic device with timing of the second electronic device using electromagnetic signals communicated between the first electronic device and the second electronic device,
wherein the first electronic device comprises two or more acoustoelectric transducers and at least one transceiver configured to send or receive electromagnetic signals, and the second electronic device comprises one or more acoustoelectric transducer and at least one transceiver configured to send or receive electromagnetic signals; and
calculating orientation of the first electronic device relative to the second electronic device based on a difference in time of arrival of one or more sound waves transmitted from or received at the two or more acoustoelectric transducers.

10. The method of claim 9, wherein each of the two or more sound waves has a frequency greater than about 19.5 kHz.

11. The method of claim 9, wherein the two or more acoustoelectric transducers of the first electronic device comprise sound sensing devices.

12. The method of claim 9, wherein the two or more acoustoelectric transducers of the first electronic device comprise sound emitting devices.

13. The method of claim 9, wherein the at least one transceiver is configured to communicate with the second electronic device using wireless communication protocols including one or more of Bluetooth, WiFi, WiMax, WiFiDirect, WiGig, ZigBee, GSM, CDMA, and LTE.

14. The method of claim 9, further comprising performing compensation calculations to account for reflection of sound waves from surfaces in vicinity of the first electronic device and/or the second electronic device.

15. An indoor positioning system comprising:
a first electronic device comprising:
at least one transceiver configured to send and/or receive electromagnetic signals used for communicating with another electronic device configured to send or receive electromagnetic signals; and
two or more acoustoelectric transducers; and
a second electronic device comprising:
at least one transceiver configured to send or receive electromagnetic signals used for communicating with another electronic device configured to send or receive electromagnetic signals; and
one or more acoustoelectric transducers,
wherein timing of each of the first electronic device and the second electronic device is synchronized using electromagnetic signals communicated between the first electronic device and the second electronic device;
wherein orientation of the first electronic device relative to the second electronic device is calculated based on a difference in times of arrival of one or more sound waves transmitted from or received at the first electronic device.

16. The indoor positioning system of claim 15, wherein each of the two or more sound waves has a frequency greater than about 19.5 kHz.

17. The indoor positioning system of claim 15, wherein the two or more acoustoelectric transducers of the first electronic device are sound emitting devices.

18. The indoor positioning system of claim 15, wherein the two or more acoustoelectric transducers of the first electronic device are sound sensing devices.

19. The indoor positioning system of claim 15, wherein each of the at least one transceiver of the first electronic device and the second electronic device is configured to communicate with another electronic device using wireless communication protocols including one or more of Bluetooth, WiFi, WiMax, WiFiDirect, WiGig, ZigBee, GSM, CDMA, and LTE.

20. The indoor positioning system of claim 15, wherein one or both of the first electronic device and the second electronic device further comprises a processor configured to execute a computer program module configured to calculate compensation to account for reflection of sound waves from surfaces in vicinity of the first electronic device and/or the second electronic device.

21.-22. (canceled)

23. A computer-readable medium comprising computer-readable code physically embodied thereon which, when executed by a processor, causes the processor to perform a method of claim 9.

24.-25. (canceled)
